(19) United States
(12) Patent Application Publication
(10) Pub. No.: US 2012/0017176 A1
(43) Pub. Date: Jan. 19, 2012

(54) METHOD AND APPARATUS FOR DISPLAYING A MENU

(75) Inventors: Won-young Choi, Suwon-si (KR); Jung-hyun Shim, Seongnam-si (KR); Kuk-Hyun Han, Yuseong-gu (KR)

(73) Assignee: Samsung Electronics Co., Ltd., Suwon-si (KR)

(21) Appl. No.: 13/183,973

(22) Filed: Jul. 15, 2011

(30) Foreign Application Priority Data
Jul. 16, 2010 (KR) 10-2010-0069167

(51) Int. Cl. G06F 3/048

(52) U.S. Cl. 715/825

(57) ABSTRACT

A method and apparatus for displaying a menu. The method includes displaying a menu page including menu items on a menu region of a display; allocating an information region on a portion of the menu region; dividing and reconfiguring the menu page in units of small pages according to a size of a reduced menu region caused by a simultaneous display of the information region and the menu page; and displaying the reconfigured menu page on the reduced menu region.

### PRIORITY

This application claims priority under 35 U.S.C. §119(a) to Korean Patent Application No. 10-2010-0069167, which was filed in the Korean Intellectual Property Office on Jul. 16, 2010, the entire disclosure of which is incorporated herein by reference.

### BACKGROUND OF THE INVENTION

1. Field of the Invention

The present invention relates generally to a menu display, and more particularly, to a method and apparatus for displaying a menu for executing an application stored in a mobile device.

2. Description of the Related Art

It is common for a mobile device to display menu pages on which menu icons for executing the applications are aligned. Also, a touch screen is often used as an input device of the mobile device.

Normally, when a menu page is initially displayed over an entire display screen and then a portion of the screen is to be used to display information other than menu information of the menu page, in order to simultaneously display the menu page and the other information, the display area for displaying the menu page is reduced.

FIGS. 1 and 2 illustrate display screen images of conventional methods of displaying a menu page on a reduced menu region.

Referring to FIG. 1, when a menu region 110 displaying a menu page including menu items corresponding to twenty four applications is displayed, and then other information is to be simultaneously displayed, the menu region 110 is divided to generate an information region 120 and a reduced menu region 130. The menu page is then re-displayed on the reduced menu region 130, and the twenty four menu items included in the menu page are reduced in size and are realigned on the reduced menu region 130. However, because the twenty four menu items are reduced in size in order to fit within reduced menu region 130, visibility is reduced and a touch error frequency increases when a user selects a menu item on a touch screen. Also, because positions of some of the menu items change, the user may find using the resized menu to be confusing.

Referring to FIG. 2, when a menu region 210 displaying a menu page including menu items corresponding to twenty four applications is displayed, and then other information is to be simultaneously displayed, the menu region 210 is divided to generate an information region 220 and a reduced menu region 230. The twenty four menu items included in the menu region 210 are realigned on the reduced menu region 230. Therefore, although the menu items are realigned without a changing in size, due to the lack of display space, the menu items are repositioned to overlap each other, the user may still find to be confusing.

### SUMMARY OF THE INVENTION

Accordingly, the present invention has been designed to solve the above-mentioned problems occurring in the prior art, and provide at least the advantages described below.

According to an aspect of the present invention, a method of displaying a menu is provided. The method includes displaying a menu page including menu items on a menu region of a display; allocating an information region on a portion of the menu region; dividing and reconfiguring the menu page in units of small pages according to a size of a reduced menu region caused by a simultaneous display of the allocated information region and the menu page; and displaying the reconfigured menu page on the reduced menu region.

According to another aspect of the present invention, an apparatus for displaying a menu is provided. The apparatus includes a display unit for displaying a menu page including menu items; and a control unit for allocating an information region on a portion of a menu region for displaying the menu page, dividing and reconfiguring the menu page in units of small pages according to a size of a reduced menu region caused by a simultaneous display of the information region and menu page, and displaying the reconfigured menu page on the reduced menu region.

### BRIEF DESCRIPTION OF THE DRAWINGS

The above and other aspects, features, and advantages of the present invention will become more apparent from the following detailed description taken in conjunction with the accompanying drawings, in which:

FIGS. 1 and 2 illustrate display screen images of conventional methods of displaying a menu page on a reduced menu region;

FIG. 3 is a block diagram illustrating an apparatus for displaying a menu, according to an embodiment of the present invention;

FIG. 4 is a flowchart illustrating a method of displaying a menu, according to an embodiment of the present invention;

FIGS. 5A through 5C illustrate display screen images for displaying and using a menu page on a reduced menu region, according to an embodiment of the present invention;

FIGS. 6A and 6B illustrate display screen images for changing menu pages on an original menu region and a reduced menu region, according to an embodiment of the present invention;

FIG. 7 illustrates display screen images for using a menu search application, according to an embodiment of the present invention; and

FIG. 8 illustrates a display screen image for selecting a menu item on a reduced menu region, according to an embodiment of the present invention.

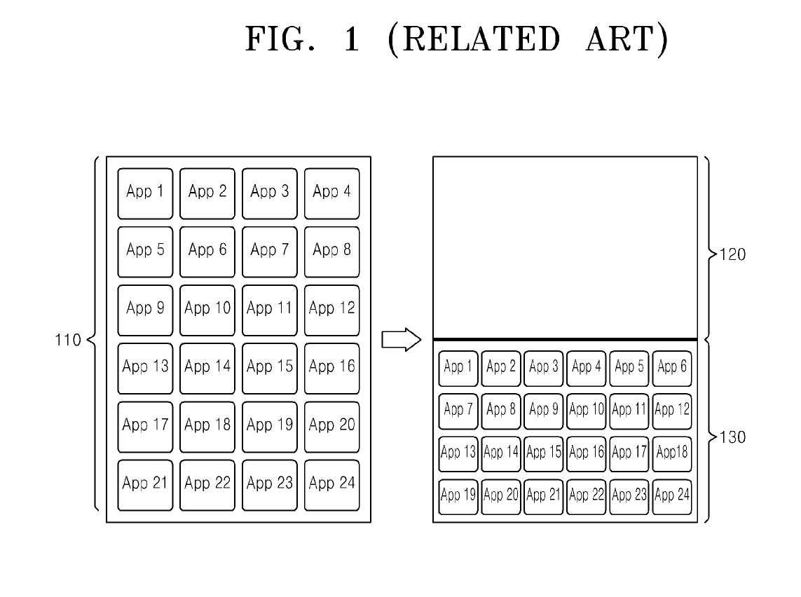

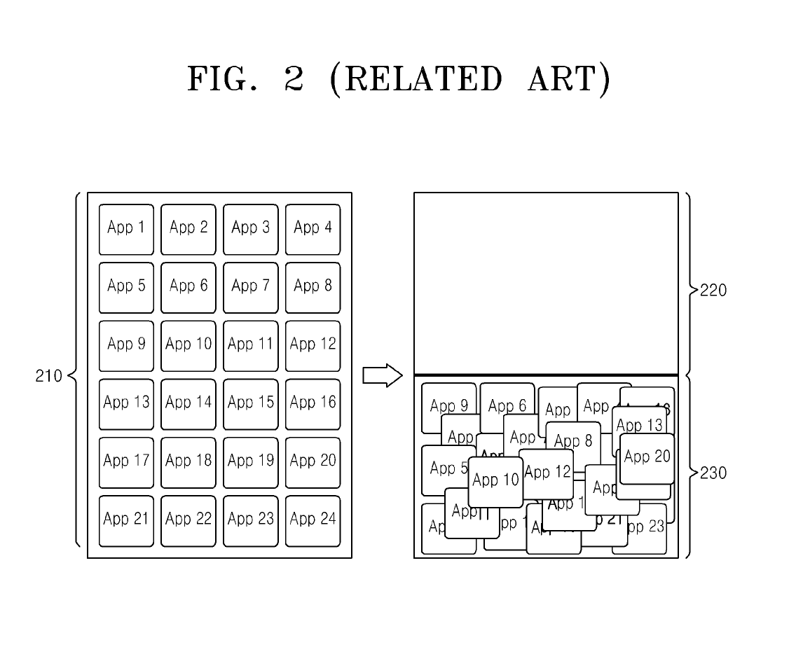

### DETAILED DESCRIPTION OF EMBODIMENTS OF THE INVENTION

Various embodiments of the present invention will be described in detail hereinafter with reference to the accompanying drawings. This present invention may, however, be embodied in many different forms and should not be construed as limited to the embodiments set forth herein. Rather, these embodiments are provided so that this disclosure will be thorough and complete, and will fully convey the scope of the invention to those skilled in the art.

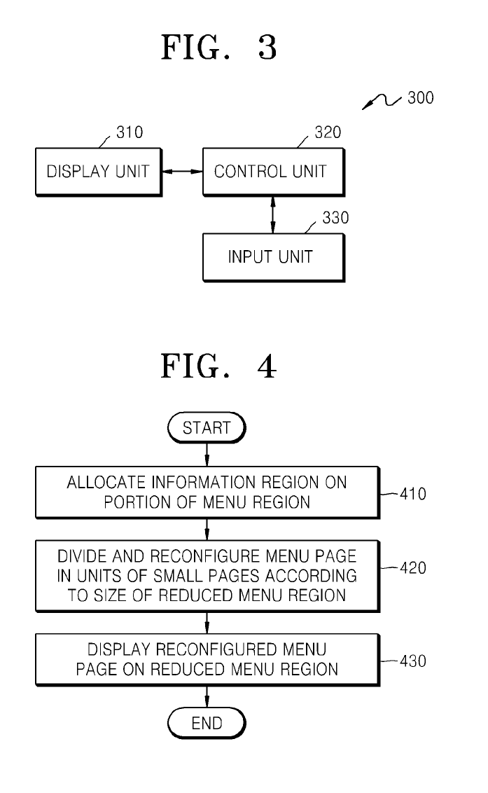

FIG. 3 is a block diagram illustrating an apparatus for displaying a menu, according to an embodiment of the present invention.

Referring to FIG. 3, the apparatus 300 includes a display unit 310 for displaying a menu page including menu items, an input unit 330 for receiving an input from a user, and a control unit 320 for controlling an output to the display unit 310. The control unit 320 allocates an information region for displaying information other than menu information of the menu page on a portion of a menu region for displaying the menu page, e.g., according to the input received by the input unit 330, and then divides, reconfigures, and displays the menu page in units of small pages according to the size of a reduced menu region caused by the simultaneous display of the information region and the menu page. For example, the display unit 310 and the input unit 330 may be realized as a touch screen capable of sensing generation and a location of a touch within a display region.

FIG. 4 is a flowchart illustrating a method of displaying a menu, according to an embodiment of the present invention.

Referring to FIG. 4, in step 410, an information region for displaying information other than information of a menu page including a plurality of menu items is allocated on a portion of a menu region for displaying the menu page. For example, a menu item may be realized as an icon, and is selected to execute a corresponding application. The menu region is divided into regions, i.e., the information region for displaying the other information and a reduced menu region for displaying the menu page. For example, the other information may be, but is not limited to, information regarding a certain application.

Step 410 may be performed according to a request of a user that is received by the input unit 330.

Because a portion of the menu region is allocated as the information region, the menu region for displaying the menu page is reduced. In order to display the menu page on the reduced menu region, in step 420, the menu page is divided and reconfigured in units of small pages that are smaller than the menu page according to the size of the reduced menu region. The reconfigured menu page is displayed on the reduced menu region in step 430. The menu items displayed on the reduced menu region maintain their respective shape, size, and alignment, as in the original menu page.

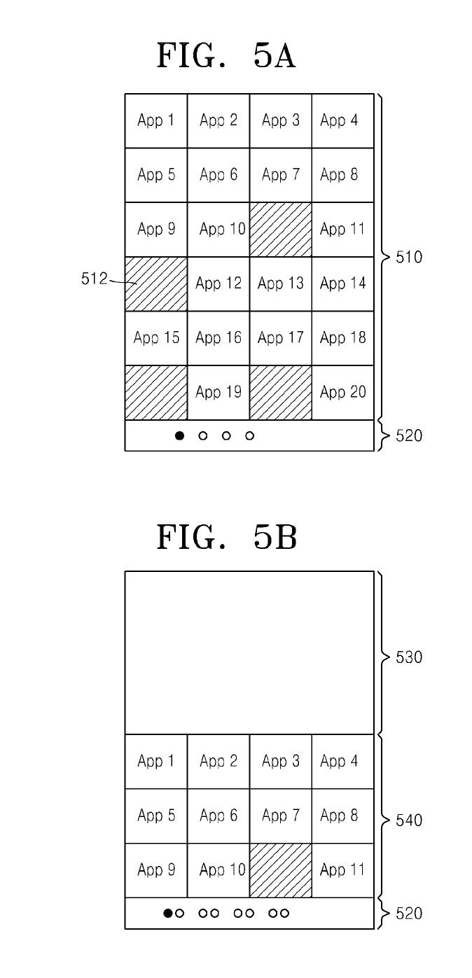

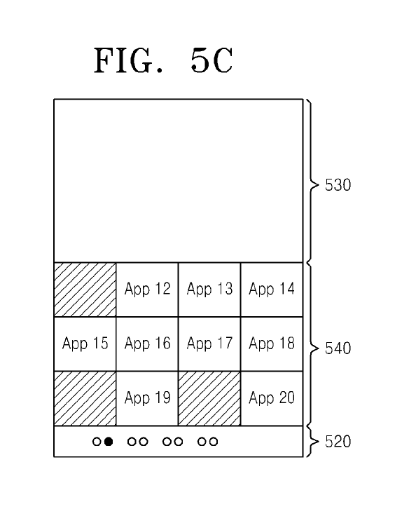

FIGS. 5A through 5C illustrate display screen images for displaying and using a menu page on a reduced menu region, according to an embodiment of the present invention.

Referring to FIG. 5A, a menu page 510 including menu items corresponding to twenty applications including a first application App1 is displayed on the screen. Shaded portions 512 are empty portions having no menu item, and may be formed according to manipulation of a user. Page indicator information 520 indicating the number of usable menu pages and also indicating a currently displayed menu page is displayed on a bottom portion of the screen. In FIG. 5A, because four page indicators are displayed and a first page indicator is displayed differently from the other page indicators, it is shown that a total of four menu pages are usable and, from among the four menu pages, a first menu page is currently being displayed.

Referring to FIG. 5B, the original menu screen displaying the menu page 510 of FIG. 5A is divided in half, creating an information region 530 for displaying information other than menu and a reduced menu region 540. The original menu page 510 is divided and reconfigured, and a first menu page of the reconfigured menu page is displayed on the reduced menu region 540. Specifically, in FIG. 5B, the first through eleventh applications App1 through App11 displayed on an upper portion of the original menu page 510 are displayed on the reduced menu region 540, and as illustrated in FIG. 5C, the twelfth through twentieth applications App12 through App20 displayed on a lower portion of the original menu page 510 are determined as a next menu page. The sizes and positions of the menu items included in the reduced menu region 540 are constantly maintained from those of the original menu items. The portion having no menu item is also constantly maintained. Further, the page indicator information 520 is updated and displayed to indicate information regarding the reconfigured menu page numbers. Because the number of menu pages is doubled, the number of page indicators is also doubled into eight.

In addition, every two pages indicators are displayed as a pair in order to indicate that one menu page is divided into two menu pages, and it is indicated that the first menu page from among the eight menu pages is currently being displayed.

As indicated above, FIG. 5C illustrates that a page change input is received on the reduced menu region 540, and the reduced menu region 540 is changed to the next menu page including the twelfth through twentieth applications App12 through App20. That is, the user may search a menu on the reduced menu region 540 while the information region 530 is open. For example, the page change input may be, but is not limited to, a flick of a finger on the screen. The next menu page displayed on the screen due to the page change input is the same as the lower portion of the original menu page 510 illustrated in FIG. 5A.

As described above, even when a menu region is divided and is reduced, because only the number of menu pages is increased and configurations, e.g., sizes, shapes, and alignments, of menu items are constantly maintained, a user may manipulate a menu without confusion. If the information region 530 is closed on the screens illustrated in FIG. 5B or 5C, the original screen illustrated in FIG. 5A may then be restored.

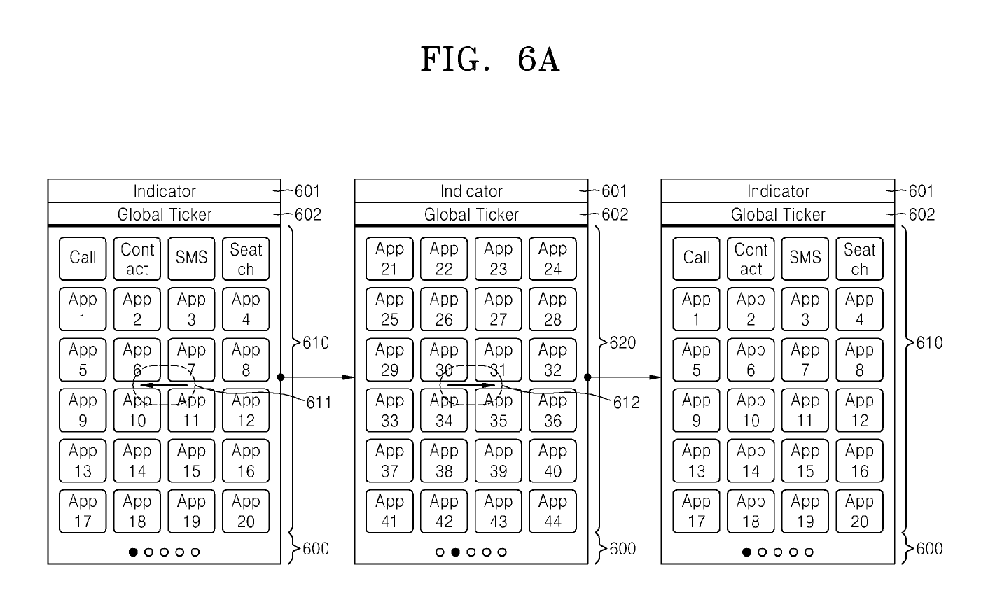

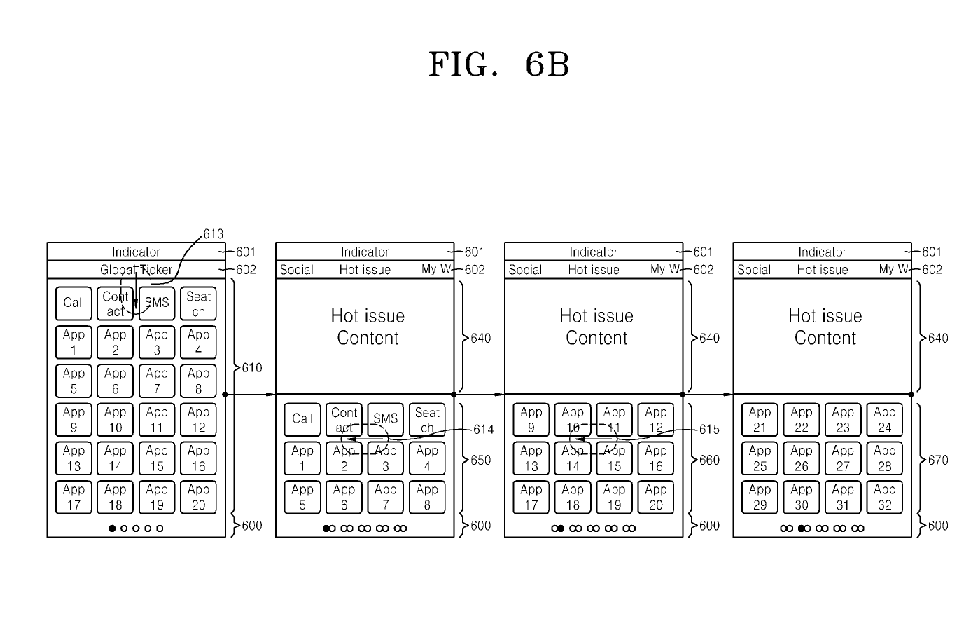

FIGS. 6A and 6B illustrate display screen images for changing menu pages on an original menu region and a reduced menu region, according to an embodiment of the present invention.

Referring to FIG. 6A, the screen includes an indicator 601 for displaying, for example, battery information of a device, a global ticker 602 for displaying recent information or recommendation information of applications, a menu region for displaying a first menu page 610 including menu items, and page indicator information 600 for displaying information regarding menu pages displayed on the menu region. If a flick input 611 for moving to a next menu page is input, i.e., a press and drag to the left, a second menu page 620 is displayed on the menu region, and the page indicator information 600 is updated and displayed to indicate that the second menu page 620 is displayed. If a flick input 612 for moving to a previous menu page is received, i.e., a press and drag to the right, the first menu page 610 is displayed again.

Referring to FIG. 6B, if a flick input 613 for moving the global ticker 602 downward is received, a global channel 640 for showing the information displayed on the global ticker 602 in detail appears, and the original menu region is reduced. The global channel 640 is an example of an information region for displaying information other than menu items in the menu page 610. The original menu page 610 is divided and reconfigured into upper and lower portions, and a first menu page 650 from among reconfigured menu pages is displayed on the reduced menu region. The number of page indicators is doubled and the page indicator information 600 is updated and displayed to indicate that the first menu page 650 from among eight menu pages is currently being displayed. The first menu page 650 may be manipulated while viewing the information displayed on the global channel 640. That is, if a leftward flick input 614 for moving to a next menu page is received on the first menu page 650, a second menu page 660 from among the reconfigured menu pages is displayed and the page indicator information 600 is correspondingly updated. If another leftward flick input 615 for moving to a next menu page is received again on the second menu page 660, a third menu page 670 from among the reconfigured menu pages is displayed and the page indicator information 600 is correspondingly updated.

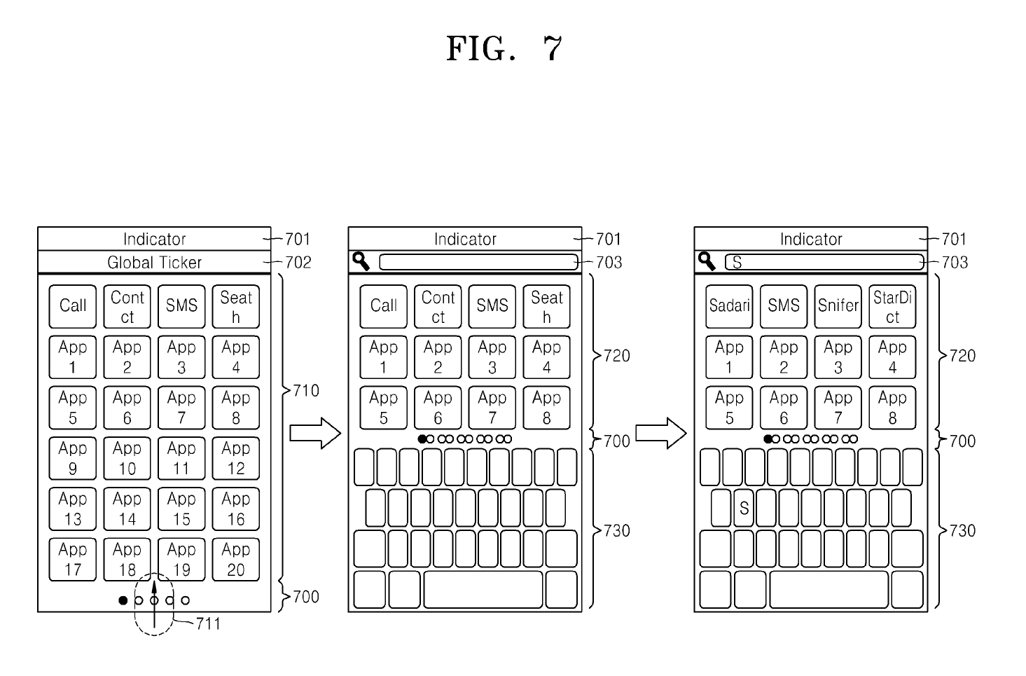

FIG. 7 illustrates display screen images for using a menu search application, according to an embodiment of the present invention.

Referring to FIG. 7, the screen includes an indicator 701 for displaying, for example, battery information of a device, a global ticker 702 for displaying recent information or recommendation information of applications, a menu region for displaying a menu page 710 including menu items, and page indicator information 700 for displaying information regarding menu pages displayed on the menu region. If an upward flick input 711 is received from a bottom of the screen, the menu region is divided in two and a keyboard interface 730 for inputting text appears on a lower portion of the screen. As such, the menu region is reduced, the menu page 710 is reconfigured into a menu page 720 having a smaller size, and the page indicator information 700 is correspondingly updated. The keyboard interface 730 is used to input a search condition for searching a menu. If the search condition is input, the menu items are realigned according to the input search condition. For example, if “S” is input as the search condition, menu items that start with the letter “S” are displayed above the other menu items. The current embodiment is an example implemented based on correlations between a reduced menu region and an information region, which are generated by dividing an original menu region.

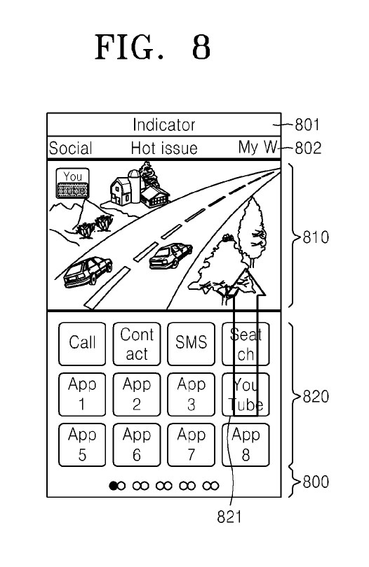

FIG. 8 illustrates a display screen image for selecting a menu item on a reduced menu region, according to an embodiment of the present invention. Specifically, FIG. 8 illustrates an example implemented based on correlations between a reduced menu region and an information region, which are generated by dividing an original menu region.

Referring to FIG. 8, the screen includes an indicator 801 for displaying, for example, battery information of a device, a global ticker 802 for displaying recent information or recommendation information of applications, a global channel region 810 newly allocated by moving the global ticker 802 downward, a menu region 820 reduced due to the allocation of the global channel region 810, and page indicator information 800 for displaying information regarding menu pages displayed on the reduced menu region 820. If a user input for selecting a certain application 821 is received or dragging of the certain application 821 upward to the global channel region 810 occurs on the screen, a remote controller function for executing the certain application 821 on the global channel region 810 is performed. For example, in FIG. 8, a YouTube® icon is selected and dragged into the global channel region 810, such that a YouTube® video is displayed on the global channel region 810.

Additionally, the present invention can also be embodied as computer readable codes on a computer readable recording medium. The computer readable recording medium is any data storage device that can store data, which can be thereafter read by a computer system. Examples of the computer readable recording medium include a Read-Only Memory (ROM), a Random-Access Memory (RAM), a Compact Disc (CD)-ROM, magnetic tape, a floppy disk, and an optical data storage device. The computer readable recording medium can also be distributed over network coupled computer systems so that the computer readable code is stored and executed in a distributed fashion.

While the present invention has been particularly shown and described with reference to certain embodiments thereof, it will be understood by one of ordinary skill in the art that various changes in form and details may be made therein without departing from the spirit and scope of the present invention as defined by the following claims and their equivalents.

What is claimed is:

1. A method of displaying a menu, the method comprising:
displaying a menu page including menu items on a menu region of a display;
allocating an information region on a portion of the menu region;
dividing and reconfiguring the menu page in units of small pages according to a size of a reduced menu region caused by a simultaneous display of the information region and the menu page; and
displaying the reconfigured menu page on the reduced menu region.

2. The method of claim 1, wherein the menu items displayed on the reconfigured menu page on the reduced menu region maintain sizes and alignments of the menu items as originally displayed on the menu page of the menu region of the display.

3. The method of claim 1, further comprising updating and displaying page indicator information that indicates a number of reconfigured menu pages.

4. The method of claim 3, wherein the page indicator information further includes information identifying a menu page currently being displayed on the reduced menu region.

5. The method of claim 1, further comprising changing the menu pages divided in units of the small pages, if a page change input is received.

6. The method of claim 1, wherein, when a half of the menu region is allocated as the information region, dividing and reconfiguring the menu page comprises:
dividing the menu page in half;
displaying an upper portion of the menu page on the reduced menu region; and
storing a lower portion of the menu page as a next reduced menu page.

7. The method of claim 6, further comprising displaying a doubled number of page indicators indicating a number of reconfigured menu pages.

8. The method of claim 1, further comprising, when the information region includes a region for inputting a search condition for searching a menu, re-aligning the menu items in the reduced menu region according to an input search condition.

9. The method of claim 1, further comprising:
selecting a menu item in the reduced menu region; and
executing an application corresponding to the selected menu item on the information region.

10. A non-transitory computer-readable recording medium having recorded thereon a computer program for executing a method of displaying a menu, the method comprising:
displaying a menu page including menu items on a menu region of a display;
allocating an information region on a portion of the menu region;
dividing and reconfiguring the menu page in units of small pages according to a size of a reduced menu region caused by a simultaneous display of the information region and the menu page; and
displaying the reconfigured menu page on the reduced menu region.

11. An apparatus for displaying a menu, the apparatus comprising:
a display unit for displaying a menu page including menu items; and
a control unit for allocating an information region on a portion of a menu region for displaying the menu page, dividing and reconfiguring the menu page in units of small pages according to a size of a reduced menu region caused by a simultaneous display of the information region and the menu page, and displaying the reconfigured menu page on the reduced menu region.

12. The apparatus of claim 11, wherein the menu items displayed on the reconfigured menu page on the reduced menu region maintain sizes and alignments of the menu items as originally displayed on the menu page of the menu region of the display.

13. The apparatus of claim 11, wherein the control unit updates and displays page indicator information that indicates a number of reconfigured menu pages.

14. The apparatus of claim 13, wherein the page indicator information further comprises information indicating a menu page currently being displayed on the reduced menu region.

15. The apparatus of claim 11, further comprising an input unit for receiving an input.

16. The apparatus of claim 15, wherein the control unit changes the menu pages divided in the units of the small pages when a page change input is received by the input unit.

17. The apparatus of claim 15, wherein, if a menu item in the reduced menu region is selected by the input unit, the control unit executes an application corresponding to the selected menu item on the information region.

18. The apparatus of claim 11, wherein, if a half of the menu region is allocated as the information region, the control unit divides the menu page in half, displays an upper portion of the menu page on the reduced menu region, and stores a lower portion of the menu page as a next reduced menu page.

19. The apparatus of claim 18, wherein the control unit displays a doubled number of page indicators indicating a number of reconfigured menu pages.

20. The apparatus of claim 11, wherein, if the information region includes a region for inputting a search condition for searching a menu, the control unit re-aligns the menu items in the reduced menu region according to an input search condition.
